(19) United States
(12) Patent Application Publication
(10) Pub. No.: US 2011/0088328 A1
(43) Pub. Date: Apr. 21, 2011

(54) OPERATING MECHANISM FOR PARKING BRAKE

(75) Inventor: Gerd Schaff, Kirchheim/Teck (DE)

(73) Assignee: Sommer Antriebs- und Funktechnik GmbH, Kirchheim (DE)

(21) Appl. No.: 12/999,482

(22) PCT Filed: Sep. 2, 2009
(86) PCT No.: PCT/EP09/06337

§ 371 Date: Dec. 16, 2010

(30) Foreign Application Priority Data
Sep. 10, 2008 (DE) 10 2008 046 538.0

(51) Int. Cl. E05F 15/18

(52) U.S. Cl. 49/358

(57) ABSTRACT

The invention relates to a drive system for a door, the door leaf of which is guided at the sides in respective guide tracks. A carriage that is guided along a guide track is connected to the door leaf. The carriage contains an intergrated drive with an autonomous power supply. The drive can be charged at a stationary charging station a wireless power supply unit. A safety device is connected via a wireless signal transmission path to a control unit that is allocated to the drive.

### CROSS-REFERENCE TO RELATED APPLICATIONS

The present application is a National Stage of International Application No. PCT/EP2009/006337, filed Sep. 2, 2009, designating the United States and claiming priority to German Application No. 10 2008 046 538.0, filed Sep. 10, 2008.

### BACKGROUND OF THE INVENTION

The invention relates to a drive system for a door.

The door which is operated with the drive system in particular is a sectional door or a sectional overhead door, wherein this door typically is a garage door.

The sections of the door are guided on the side inside guide tracks extending along the door frame and along the ceiling of the garage. Known drive systems for doors of this type are provided with a motor that moves along one of the guide tracks. The motor is positioned on a console or the like which is positioned so as to move with rollers in the guide track. A push rod is attached articulated to the console and is also connected articulated to the upper door slat. The door is opened or closed by moving the motor back and forth along the guide tracks.

A drive system of this type is known from the document DE 10 2005 053 560 A1, in which it is mentioned that a storage battery which serves as autonomous energy supply unit is provided in addition to a supply network connection for the motor.

The document DE 94 06 829 U1 discloses an electromotor door drive, provided with a motor which does not move in one of the guide tracks for the door but in a separate guide track. This drive system also comprises an autonomous energy supply, comprising a storage battery which can be charged up at a charging station through the transfer of energy, if applicable in a non-contacting manner.

### SUMMARY OF THE INVENTION

It is an object of the invention to make available a drive system of the aforementioned type which has a simple design along with high functionality.

According to one embodiment disclosed herein, a drive system is used for operating a door having a door leaf that is guided on the side in respectively one guide track. A carriage that moves along a guide track is connected to the door leaf, wherein a drive with autonomous energy supply is integrated into the carriage. The drive can be charged up at a stationary charging station with the aid of a wireless energy transfer device. A safety device is connected via a wireless signal transmission path to a control unit that is assigned to the drive.

One aspect of the invention is that a wireless, preferably bi-directional data transfer takes place between the control for the drive and the safety device and that the drive is provided with an autonomous energy supply, wherein the autonomous energy supply is charged up contactlessly, meaning without making contact, in particular by a inductive or capacitive mechanism. No cables or wires are thus needed for this unit, thereby considerably reducing the installation expenditure for the drive system according to the invention.

The installation expenditure may be reduced even further if the safety device is also provided with an autonomous energy supply and consequently also may not require any feed lines for its energy supply.

The autonomous energy supply for the drive advantageously may take the form of a storage battery. However, a fuel cell or the like can alternatively also be provided for use as the autonomous energy supply. The autonomous energy supply for the safety device can take the form of a storage battery or also a solar cell.

The energy transfer device, which is assigned to the autonomous energy supply for the drive, may be provided at one of the end positions for the carriage and thus the drive, wherein the door is closed completely in the first end position and the door is opened completely in the second end position. These end positions may be defined by limit switches which can be displaced along the guide track. In the simplest case, the energy transfer device may be assigned as a separate unit to one of the limit switches. One of the limit switches may function as an energy transfer device, thus resulting in simple and cost-effective design.

The lower edge of the door leaf may be monitored with the aid of the safety device, wherein the safety device may take the form of a light-barrier arrangement.

The signal transmission path for the contactless bi-directional data transfer between the safety device and the control unit may be a radio link.

The drive system may have a modular configuration, wherein the carriage with the drive can be mounted without tools on a guide track for the door. No structural changes or adaptations may be required on the guide track during the installation of the carriage. The carriage may be provided with a suitable guide mechanism which can be inserted into the guide tracks and can be guided inside the guide tracks during the operation of the drive system. In one embodiment the drive may be a friction-wheel drive. In that case, at least one friction wheel may be provided which is driven by the drive and is guided frictionally engaged inside the guide track. The drive with the guide mechanism may be embodied such that it can be installed on differently designed guide tracks.

Since the drive for activating the door leaf is moved along a guide track, extending on the side, for guiding the door leaf, the force exerted by the drive onto the door leaf is correspondingly one-sided and non-symmetrical. With large door widths, this can result in an undesirable tilting of the upper edge of the door leaf and thus in an irregular guidance of the door leaf. Not only does this increase the wear of the mechanical components, but it can also result in causing problems with the function of the safety device. To prevent these types of problems, a carriage with therein integrated drive can respectively be provided on each guide track, wherein these drives may be embodied identically. In particular, these drives have the same autonomous energy supply with an associated energy transfer device.

### BRIEF DESCRIPTION OF THE DRAWINGS

The invention is explained in the following with the aid of the drawings, which show in:

FIG. 1: A schematic representation of a drive system for a door.

FIG. 2: An enlarged representation of a portion of the arrangement according to FIG. 1, comprising a carriage with integrated drive which is guided along a guide track.

### DETAILED DESCRIPTION

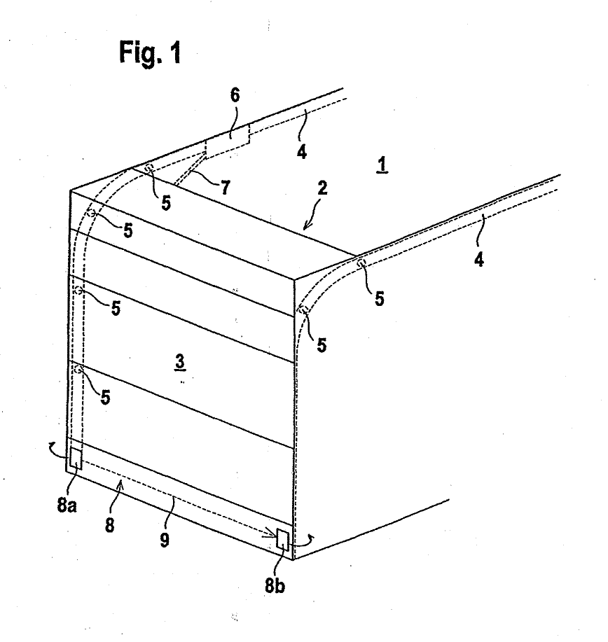

FIG. 1 schematically shows an embodiment of the door drive system 1 according to the invention. For the present case, the door is embodied as a sectional door 2 with a door leaf 3 which moves inside two guide tracks 4 on the side that are installed on a building, a garage in the present case.

As shown in FIG. 1, the garage opening can be closed off with the door leaf 3. In the closed position of the door, the door leaf 3 is located in the region of the vertically extending segments of the guide track 4. In the opened position of the door, the door leaf 3 is located in the region of the horizontally extending segments of the guide track 4, below the garage ceiling. Guide rolls 5 that move inside the guide tracks 4 may be provided on both side edges of the door leaf 3.

A motor-driven carriage 6 which moves in one of the guide tracks 4 may be provided for the opening and closing of the door. With the aid of a push rod 7, the carriage 6 may be connected articulated to the upper edge of the door leaf 3. A different type of connecting element can also be used in place of a push rod 7. The door can be opened or closed by moving the carriage 6 back and forth in the region of the horizontal segment of the guide track 4.

A safety device may be used to monitor the lower edge of the door and may be installed on the lower border for the door leaf 3. An object intervention in this region is detected by the safety device as a danger-causing situation. If such a situation occurs, the door movement is stopped for safety reasons.

The safety device can generally be embodied as a mechanical device with contacts. The safety device may operate contactlessly. In the present case, the safety device essentially may consist of a light barrier 8. This light barrier 8 may comprise a transmitter 8a for emitting light rays 9 and a receiver 8b for receiving light rays 9, wherein these may be arranged at opposite edges of the door leaf 3. If no object intervention is detected, the light rays 9 emitted by the transmitter 8a are conducted directly below the lower edge of the door leaf 3 and parallel thereto to the receiver 8b. In case of an object intervention, the path of the light rays 9 is interrupted, thereby generating an object report in the light barrier 8 which results in a stop of the door movement.

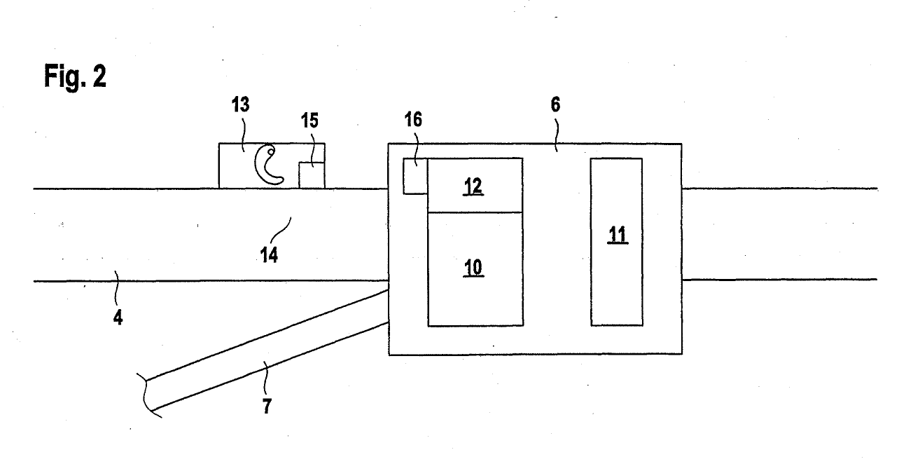

FIG. 2 shows an enlarged section of the guide track 4 with thereon arranged carriage 6.

A drive 10 in the form of an electric motor and a control unit 11 for controlling the door functions of, in particular, the drive 10 may be arranged inside the carriage 6.

The carriage 6 with integrated drive 10 in the form of a modular unit can optionally be installed on one of the guide tracks 4. The carriage 6 may be installed without tools on the guide track 4 and without structural interference with the guide track 4. This can be achieve by providing a friction-wheel drive inside the carriage 6, meaning the drive 10 inside the carriage 6 drives one or several friction wheels which are guided frictionally engaged inside the guide track 4. These friction wheels can simply be inserted into the guide track 4. An adaptation of the friction wheel to different guide tracks 4 may be possible through a suitable dimensioning and arrangement of the friction wheels.

The drive 10 may be provided with an autonomous energy supply unit in the form of a storage battery 12. In general, a fuel cell or the like can also be provided for this.

In the same way, the safety device can also be provided with an autonomous energy supply unit, not shown herein, which can be a solar cell or also a storage battery 12.

As a result of using an autonomous energy supply unit, no cables or wires are required either for the drive 10 or for the safety device. The communication between the control unit 11 and the safety device furthermore also occurs contactlessly, via a signal transmission path that is not shown separately herein. The signal transmission path in the present case may be a radio link which is used for a bi-directional data transfer. Respectively one radio transmitter and one radio receiver are provided for this in the safety device as well as in the control unit 11. The signals generated in the safety device may be transferred via the radio link to the control unit 11, so that the control unit 11 can stop the drive with the aid of the safety device if an object intervention is reported.

Along the horizontal region of the guide track 4, the carriage 6 can move back and forth along a predetermined movement path. The end positions of the carriage 6 for the completely opened and the completely closed door are predetermined by the limit switches 13, which are arranged displaceable and thus adjustable on the guide track 4. FIG. 2 shows the limit switch 13 for the closed position of the door. In this closed position, the carriage 6 rests against the limit switch 13 and is secured thereon with the aid of a locking element 14. In general, a motor brake or a similar configuration for the drive 10 can also be used for the locking operation.

Since the charging capacity of the storage battery 12 for the drive 10 is limited, the storage battery may be charged up at predetermined intervals at a charging station, wherein the charging station may be positioned at the location of one of the two limit switches 13 since these are the locations where the carriage 6 is stopped in the end positions.

The charging station for the present embodiment may be arranged in the limit switch 13, shown in FIG. 2, for the closed position of the door. The charging station in general is provided with a net voltage connection, not shown herein, as well as with an energy transfer device 15 for transferring energy to the storage battery 12. A wireless energy transfer may be possible with this energy transfer device 15. Known devices provided with contacts, such as plug-in systems, can generally also be used and function as hard-wired energy transfer devices.

An inductive energy transfer occurs in the present case, for which the energy transfer device 15 may be provided with a coil arrangement. A transfer module 16 which comprises such a coil arrangement may be installed in the carriage 6. With this energy transfer device 15, a voltage transformation may occur along with the energy transfer. Thus, the electrical components in the carriage 6 need not be laid out for the net voltage of 230V, but can also be laid out for a lower voltage, for example a voltage near 12V. Instead of the inductive energy transfer, a capacitive energy transfer can generally also take place.

With larger door widths, the force exerted from one side onto the door leaf 3 by the drive 10 that is guided along one guide track 4 can have a negative effect. In that case, a separate carriage 6 with therein integrated drive 10 and autonomous energy supply unit can be provided in each guide track 4, wherein these arrangements may be embodied identically and correspond to the arrangements as shown in FIGS. 1 and 2.

The movement of the drives 10 may be controlled by the control unit 11 which is preferably integrated into one of the carriages 6. A computer unit can then be integrated in the second carrige 6 which, for example, receives control signals from the control unit 11 via a radio link.

1. A drive system for a door the door having a door leaf and being guided on each side by respectively one guide track, the drive system comprising:
a carriage adapted to be guided along one of the guide tracks and constructed to be connected to the door leaf, wherein the carriage—includes a control unit and an integrated drive having an autonomous energy supply unit, wherein the integrated drive is chargeable at a stationary charging station;
a wireless energy transfer device arranged at the stationary charging station to wirelessly transfer energy to the autonomous energy supply unit; and
a safety device connected by a wireless signal transmission path to the control unit in the integrated drive.

2. The drive system according to claim 1, wherein the carriage with the integrated drive is installable without tools on the guide track.

3. The drive system according to one of the claims 1, wherein the integrated drive comprises a friction-wheel drive.

4. The drive system according to claim 3, wherein the integrated drive includes at least one friction wheel that moves in the guide track.

5. The drive system according to claim 1, wherein the safety device is arranged to monitors a lower edge of the door leaf.

6. The drive system according to claim 5, wherein the safety device comprises a light barrier arrangement.

7. The drive system according to claim 1, wherein the wireless signal transmission path comprises a radio link by which a bi-directional data transfer takes place.

8. The drive system according to claim 1, wherein the safety device includes an autonomous energy supply unit.

9. The drive system according to claim 1, wherein the autonomous energy supply unit of the integrated drive comprises one of a storage battery or a fuel cell.

10. The drive system according to claim 1, wherein the autonomous energy supply unit of the safety device comprises one of a storage battery or a solar cell.

11. The drive system according to claim 1, further in comprising a limit switch arranged to limit a back and forth movement of the carriage and which is adapted to operate as the energy transfer device for the integrated drive.

12. The drive system according to claim 1, wherein the energy transfer device is adapted to transfer one of an inductive or a capacitive energy.

13. The drive system according to claim 1, and further comprising a second carriage connected to the door leaf and arranged to move in the other guide track wherein the second carriage includes an integrated drive having an autonomous energy supply unit.

14. The drive system according to claim 13, wherein the integrated drives and components assigned to the two guide tracks are embodied identically.

15. The drive system according to claim 13, further including a control unit arranged in one of the two carriages, wherein both integrated drives are controlled by the control unit.
